(19) United States
(12) Patent Application Publication
(10) Pub. No.: US 2025/0211888 A1
(43) Pub. Date: Jun. 26, 2025

(54) REGULATING DEVICE AND AUDIO STAND

(71) Applicant: TILTA INC., Burbank, CA (US)

(72) Inventors: Yaolong LUO, Shenzhen (CN); Wenping ZENG, Shenzhen (CN); Kefeng ZHOU, Shenzhen (CN)

(21) Appl. No.: 18/989,538

(22) Filed: Dec. 20, 2024

(30) Foreign Application Priority Data
Dec. 21, 2023 (CN) 2023235073360

(51) Int. Cl. H04R 1/08; F16M 11/06

(52) U.S. Cl. CPC H04R 1/08; F16M 11/06

(57) ABSTRACT

This disclosure pertains to the field of photographic equipment technology and presents a regulating device including a first mounting member and a second mounting member, wherein the second mounting member is movably connected to the first. A first regulating component is movably coupled to both the first and second mounting members to facilitate their relative movement towards or away from each other. In some aspects, a support rod may be attached to the first mounting member, allowing a user to adjust the angle between the first and the second mounting members by manipulating the first regulating component, thereby altering the inclination of the support rod. In summary, the user can position the support rod at a suitable angle through the first regulating component to facilitate shooting tasks.

### CROSS-REFERENCE TO RELATED APPLICATIONS

The present application for patent claims priority to and the benefit of pending Chinese Application No. 2023235073360, filed Dec. 21, 2023, and hereby expressly incorporated by reference herein as if fully set forth below in its entirety and for all applicable purposes.

### TECHNICAL FIELD

The present utility model pertains to the technical realm of photographic equipment, specifically to a regulating device and an audio stand.

### INTRODUCTION

During the production of TV dramas, movies, advertisements, live sports events, and similar endeavors, sound recording is invariably necessary. Consequently, microphones are essential equipment during filming. Conventionally, microphones are mounted on one end of a stand pole, while staff hold the other end with both hands to position the microphone near the subject. In prolonged filming scenarios, this can lead to arm discomfort for the staff. In response, a novel audio stand has emerged in the market, featuring a microphone mounted on one end of the stand pole and a support pole mounted on the other. Staff can wear a backpack, attaching the end of the support pole opposite the stand pole to the backpack, thereby enabling them to hold one end of the stand pole with one hand. However, during the filming process, the support pole needs to be adjusted to accommodate the varying usage preferences of individual staff members to facilitate adjustments to the stand pole for sound recording.

### BRIEF SUMMARY

The present disclosure is to provide a regulating device and an audio stand that address the issue in the prior art, wherein, during filming, adjustments to the support pole are required to cater to the different usage preferences of staff members for sound recording adjustments.

To resolve the aforementioned technical challenge, the technical solution offered is as follows:

a regulating device, including:

a first mounting member;

a second mounting member movably connected to the first mounting member;

a first regulating component is movably coupled to both the first and the second mounting members, so that the first and the second mounting members can move towards or away from each other relatively.

Furthermore, the present disclosure introduces an audio stand that includes a stand pole, a support pole, and the aforementioned regulating device. The stand pole serves to mount a microphone, with one end of the support pole movably connected to the stand pole and the other end connected to the regulating device.

### Beneficial Effects

In the present disclosure, a support rod may be attached to the first mounting member, allowing a user to adjust the angle between the first and the second mounting members by manipulating the first regulating component, thereby altering the inclination of the support rod. In summary, the user can position the support rod at a suitable angle through the first regulating component to facilitate shooting tasks.

### BRIEF DESCRIPTION OF THE DRAWINGS

To elucidate the technical solutions presented in the embodiments of the present disclosure or the prior art, the accompanying drawings necessary for describing these embodiments or the prior art will be briefly introduced below. It is apparent that the accompanying drawings described herein represent merely some embodiments of the present disclosure. For those skilled in the art, without the necessity for inventive effort, other drawings can be derived based on the structures depicted in these drawings.

FIG. 1 is a diagram illustrating an audio stand according to some aspects of the disclosure.

FIG. 2 is diagram illustrating a front view of a regulating device according to some aspects of the disclosure.

FIG. 3 is diagram illustrating an exploded view of the regulating device according to some aspects of the disclosure.

FIG. 4 is diagram illustrating another exploded view of the regulating device according to some aspects of the disclosure.

FIG. 5 is a cross-sectional diagram of the regulating device according to some aspects of the disclosure.

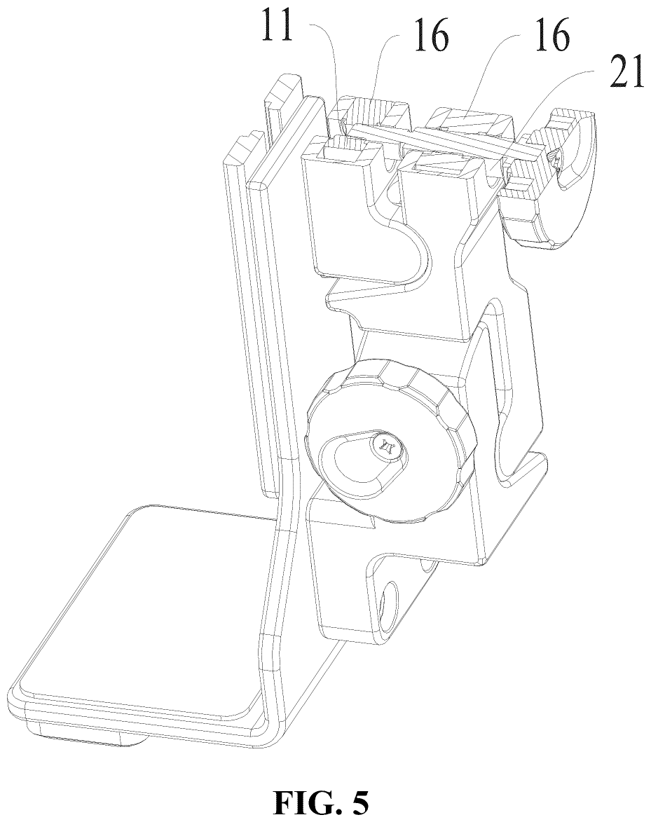

REFERENCE NUMERALS OF ELEMENTS IN THE DRAWINGS

100—audio stand; 10—regulating device; 20—stand pole; 30—support pole; 40—adjustment pole;

1—first mounting member; 11—first mounting hole; 12—first movable slot; 13—first projection; 14—first limiting member; 15—rotating shaft; 16—pivot;

2—second mounting member; 21—second mounting hole; 22—third mounting hole; 24—first side; 241—first rotating slot; 2411—second projection; 25—second side; 251—second movable slot; 252—third projection; 26—first movable projection; 27—second limiting member;

3—first regulating component; 31—first external thread; 32—second external thread;

4—third mounting member; 41—fourth mounting hole; 42—second movable projection; 43—second rotating slot; 431—fourth projection;

5—second regulating component; 51—third external thread; 52—fourth external thread;

6—mounting base; 61—first base body; 611—back-up block; 62—second base body; 621—hook; 63—washer.

The objectives, functional characteristics, and advantages of the present invention will be further elucidated with reference to the embodiments and accompanying drawings.

### DETAILED DESCRIPTION

The subsequent passages provide a precise and exhaustive portrayal of the technical solutions embodied within this disclosure, drawing upon the illustrative figures. It is to be understood that the enumerated embodiments constitute but a fraction of the broader scope and are not exhaustive. Consequently, any alternative embodiments derived by ordinary technicians in the relevant field, without the necessity for inventive ingenuity, are encompassed within the protective ambit of this disclosure.

Please be advised that directional terminology (e.g., up, down, left, right, front, rear, etc.) employed in the embodiments serves exclusively to elucidate the relative positional arrangements and dynamic states among components within a specific orientational framework as depicted in the drawings. In the event of a change in this orientational framework, the directional designations will naturally align with the new configuration.

Furthermore, the utilization of ordinal indicators such as “first,” “second,” and so forth, in this disclosure, is purely for descriptive clarity and cannot be misconstrued as signifying relative significance or implicitly indicating the number of technical features referenced. As such, expressions constrained by such ordinal designations may encompass one or more of the indicated features, either explicitly or implicitly. Moreover, the phrase “and/or” used throughout this document encompasses three distinct possibilities: Taking A and B as examples, it embraces the technical solution exclusive to A, the technical solution exclusive to B, as well as the technical solution that concurrently satisfies both A and B. Additionally, the integration of technical solutions across distinct embodiments is permissible, albeit contingent upon the feasibility of such integration by ordinary technicians in the field. In instances where the combined technical solutions conflict or are unfeasible, such integrations are deemed non-existent and thereby excluded from the scope of protection afforded by this disclosure.

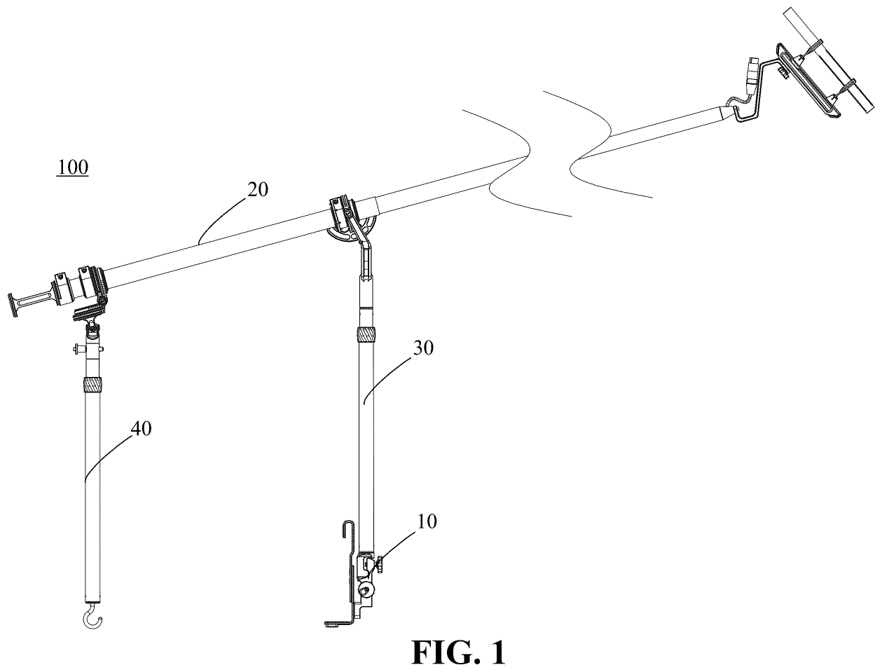

Referring to FIGS. 1-4. The present disclosure provides an audio stand 100 that includes a stand pole 20, a support pole 30, and a regulating device 10. The regulating device 10 serves to mount the support pole 30 onto a backpack. The stand pole 20 is intended for mounting a microphone. One end of the support pole 30 is movably connected to the stand pole 20, while the other end is connected to the regulating device 10. In some aspects, users can flexibly alter the inclination angle of the support pole 30 relative to the backpack as per their requirements. For instance, in some aspects, some users may prefer the support pole 30 to be initially in a vertical state, which can be accomplished by adjusting the regulating device 10 to position the support pole 30 vertically for ease of use. Another scenario is when users of different body shapes wear the backpack, the support pole 30 may exhibit varying angles. To adjust the support pole 30 to the desired angle, users can manipulate the regulating device 10 to set the support pole 30 at the appropriate angle. In some aspects, the audio stand 100 also incorporates an adjustment pole 40 mounted on the end of the stand pole 20 farthest from the microphone. Once the support pole 30 is mounted on the backpack, users can grasp the adjustment pole 40 to modify the rotation of the stand pole 20.

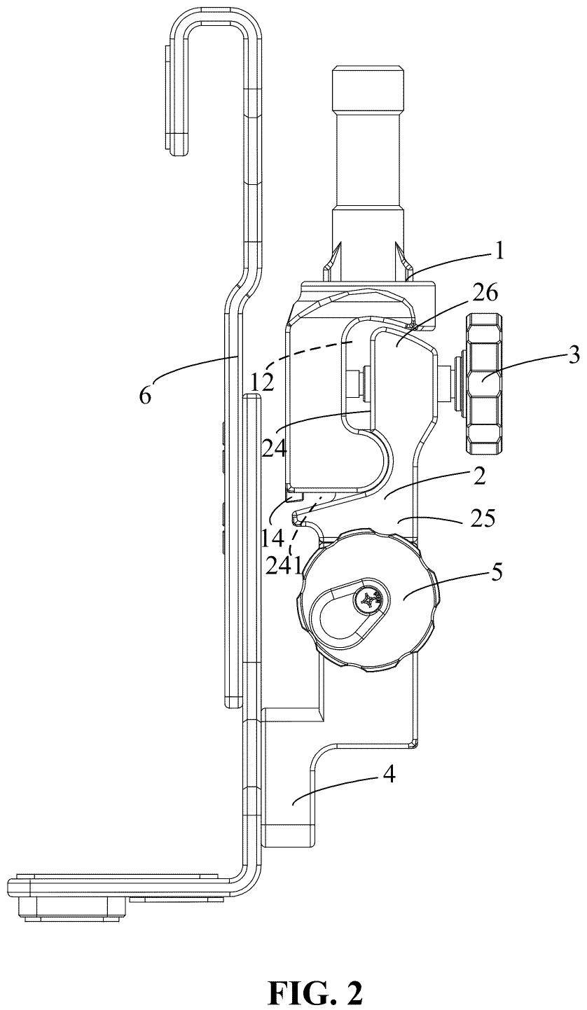

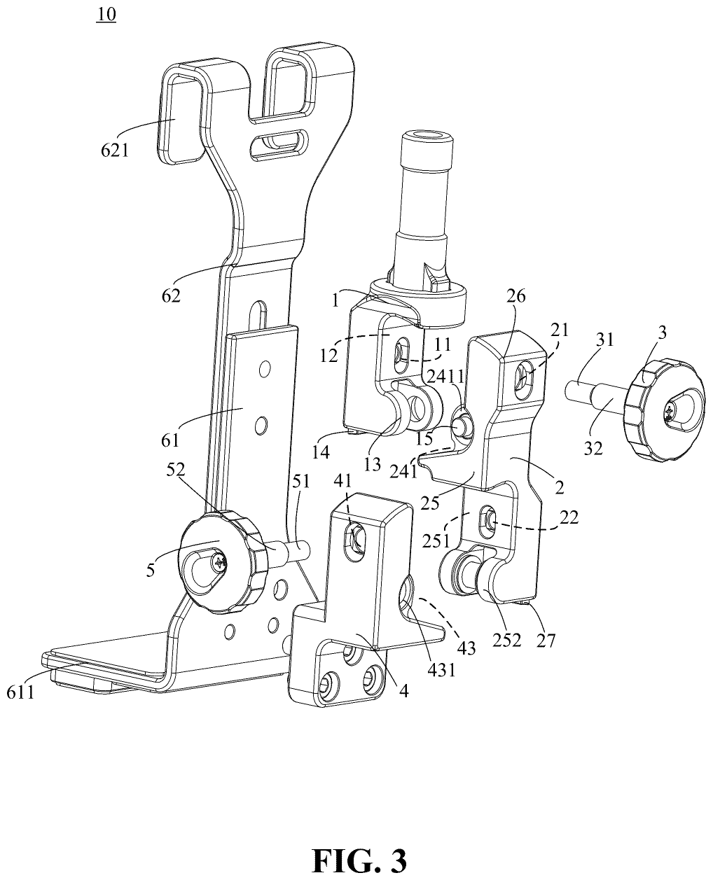

Referring to FIGS. 2-3. The regulating device 10 includes a first mounting member 1, a second mounting member 2, and a first regulating component 3. The second mounting member 2 is movably connected to the first mounting member 1. The first regulating component 3 is movably connected to both the first mounting member 1 and the second mounting member 2 to modify the relative distance between them, allowing them to move closer or farther apart. In some aspects, the first regulating component 3 is connected to the first mounting member 1 and the second mounting member 2 via two pivots, respectively.

In some aspects, the support pole 30 can be attached to the first mounting member 1. By adjusting the first regulating component 3, users can change the angle between the first mounting member 1 and the second mounting member 2, thereby altering the inclination of the support pole 30. In summary, users can adjust the support pole 30 to a suitable angle via the first regulating component 3 to facilitate filming.

Specifically, the surface of the first regulating component 3 features a first external thread 31 and a second external thread 32. The first mounting member 1 has a first mounting hole 11, and the second mounting member 2 has a second mounting hole 21. The first mounting hole 11 and the second mounting hole 21 are internally threaded with a first internal thread and a second internal thread, respectively (e.g., two pivots are internally threaded with a first internal thread and a second internal thread). The first regulating component 3 is inserted sequentially through the second mounting hole 21 and the first mounting hole 11, with the first external thread 31 engaging with the first internal thread and the second external thread 32 engaging with the second internal thread. For instance, when users rotate the first regulating component 3, the thread directions of the first external thread 31 and the second external thread 32 cause the first mounting member 1 and the second mounting member 2 to move towards or away from each other along the axial direction of the first regulating component 3.

In another aspect, the adjustment of the support pole 30 can be made even more versatile. For example, the regulating device 10 further includes a third mounting member 4 and a second regulating component 5. The third mounting member 4 is movably connected to an end of the second mounting member 2 opposite to the first mounting member 1, and the second regulating component 5 is movably coupled to both the second member 2 and the third mounting member 4, so that the first and the second member 2 and the third mounting member 4 can move towards or away from each other relatively. In some aspects, the second regulating component 5 is connected to the second member 2 and the third mounting member 4 via two pivots, respectively.

Specifically, the surface of a second regulating component 5 is equipped with a third external thread 51 and a fourth external thread 52. The second mounting member 2 has a third mounting hole 22, and a third mounting member 4 has a fourth mounting hole 41. The third mounting hole 22 and the fourth mounting hole 41 are internally threaded with a third internal thread and a fourth internal thread, respectively (e.g., two pivots are internally threaded with a third internal thread and a fourth internal thread). The second regulating component 5 is inserted sequentially through the fourth mounting hole 41 and the third mounting hole 22, with the third external thread 51 engaging with the third internal thread and the fourth external thread 52 engaging with the fourth internal thread. For example, when users rotate the second regulating component 5, the thread directions of the third external thread 51 and the fourth external thread 52 cause the third mounting member 4 and the second mounting member 2 to move towards or away from each other along the axial direction of the second regulating component 5. In some aspects, when the first regulating component 3 and the second regulating component 5 are mounted on the same side or opposite sides of the second mounting member 2, the adjustment angles of the first regulating component 3 and the second regulating component 5 can be superimposed. For instance, by turning the first regulating component 3, the first mounting member 1 and the second mounting member 2 move apart; further turning the second regulating component 5 results in the second mounting member 2 and the third mounting member 4 moving apart. The support pole 30 is mounted on the first mounting member 1, and the third mounting member 4 can be utilized for mounting on a backpack. Thus, the adjustable angle of the support pole 30 relative to the third mounting member 4 is enhanced. In another aspect, the direction of inclination of the support pole 30 can be modified in multiple ways. For instance, the second mounting member 2 features adjacent first side 24 and second side 25. The first mounting member 1 is movably connected to the first side 24 of the second mounting member 2, and the third mounting member 4 is movably connected to the second side 25 of the second mounting member 2. Taking the perspective shown in FIG. 2 as a reference, adjusting the first adjustment component 3 allows for adjustment of the angle between the first mounting member 1 and the second mounting member 2 in the left-right direction, thereby modifying the left-right inclination angle of the support rod 30. Similarly, adjusting the second adjustment component 5 permits adjustment of the angle between the second mounting member 2 and the third mounting member 4 in the front-rear direction, altering the front-rear inclination angle of the support rod 30. It is noted that the directions referenced in this paragraph change accordingly with changes in the viewing perspective.

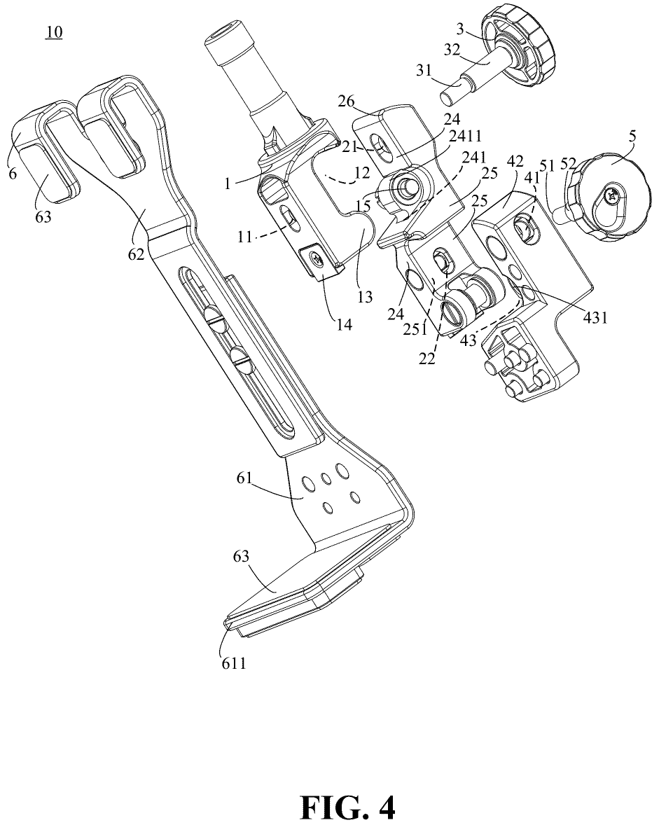

Referring to FIGS. 3-4. In some aspects, one of the first and the second mounting members 1 and 2 incorporates a first movable slot 12, while another includes a first movable projection 26. When the first regulating component 3 is adjusted, the first movable projection 26 moves relative to the first movable slot 12. In some aspects, the first mounting member 1 features a first movable slot 12, while the second mounting member 2 includes a first movable projection 26. When the first adjustment component 3 is rotated to bring the first and second mounting members closer together, the first movable projection 26 rotates towards the first movable slot 12 until it engages with the inner wall of the slot, restricting the rotation of both mounting members 1 and 2.

In another aspect, an end of the first mounting member 1 adjacent to the second mounting member 2 is equipped with a first projection 13. The second mounting member features a rotating slot 241 with a second projection 2411 positioned internally. The first and the second projections 13 and 2411 are rotatably connected, enabling the first projection 13 to rotate relatively to the rotating slot 241. A first limiting member 14 is located at the end of the first mounting member 1 adjacent to the second mounting member 2. This first limiting member 14 can come into contact with a first rotating slot 241 to limit the rotation of a first projection 13. As the first adjustment component 3 rotates to separate the first and second mounting members, the first projection 13 and a corresponding second projection 2411 rotate relative to each other, with the first movable projection 26 rotating away from the first movable slot 12 until the first limiting member 14 engages with the inner wall of the first rotating slot 241, thereby limiting the rotation of the first projection 13. It is noted that the first projection 13 and the second projection 2411 are connected by a rotating shaft 15, preferably a damper shaft 15 for added stability.

In another aspect, one of the second mounting member 2 and the third mounting member 4 incorporates a second movable slot 251, while the other has a second movable projection 42. Adjusting the second adjustment component 5 allows the second movable projection 42 to move relative to the second movable slot 251. Specifically, in some aspects, the second side 25 of the second mounting member 2 features the second movable slot 251, while the third mounting member 4 includes the second movable projection 42. When the second adjustment component 5 is rotated to bring the second member 2 and the third mounting member 4 closer together, the second movable projection 42 rotates towards the second movable slot 251 until it engages with the inner wall, restricting the rotation of both the second member 2 and the third mounting member 4. In another aspect, the second side 25 of the second mounting member 2 also has a third projection 252, while the third mounting member 4 has a second rotating slot 43 with an inner wall featuring a fourth projection 431. The third projection 252 and the fourth projection 431 are rotatably connected, enabling the rotation of the third projection 252 relative to the second rotating slot 43. A second limiting member 27 is provided at the end of the second mounting member 2 opposite to the first mounting member 1. This second limiting member 27 can engage with the second rotating slot 43 to limit the rotation of the third projection 252. When the second adjustment component 5 rotates to separate the third and second mounting members, the third projection 252 and the fourth projection 431 rotate relative to each other, with the second movable projection 42 rotating away from the second movable slot 251 until the second limiting member 27 engages with the inner wall of the second rotating slot 43, thereby limiting the rotation of the third projection 252. The third projection 252 and the fourth projection 431 are connected by a shaft 15, preferably a damping shaft for enhanced stability.

Referring to FIGS. 3 and 4. The regulating device 10 further includes a mounting base 6 securely attached to the third mounting member 4. The mounting base 6 includes a first base body 61 and a second base body 62. A first end of the first base body 61 is movably connected to the second base body 62, while a second end features a back-up block 611. One end of the second base body 62 opposite to the first base body 61 is equipped with a hook 621. In some aspects, the first base body 61 is mounted on the bottom of the backpack using the back-up block 611, while the second base body 62 can be hung on the inner layer of the backpack via the hook 621, making the mounting base 6 mounted on the backpack. Depending on the backpack's size, the first base body 61 and the second base body 62 can be adjusted relative to each other to fit backpacks of varying dimensions. It is noted that both the back-up block 611 and the hook 621 are equipped with washers 63 to enhance friction with the backpack and prevent wear on the material.

It is emphasized that the aforementioned embodiments serve as preferred illustrations and do not constitute limitations on the scope of the patent claims presented herein. Any structural modifications that are deemed equivalent, based on the disclosure and drawings of this disclosure, or their direct/indirect disclosure in related technical domains, fall within the ambit of patent protection afforded to this disclosure, in line with its underlying concept.

What is claimed is:

1. A regulating device, comprising:
a first mounting member;
a second mounting member movably connected to the first mounting member; and
a first regulating component is movably connected to both the first mounting member and the second mounting member, and is configured to adjust the first mounting member and the second mounting member to move relative to each other.

2. The regulating device according to claim 1, wherein the regulating device further comprises a third mounting member and a second regulating component; and
wherein the third mounting member is movably connected to an end of the second mounting member opposite to the first mounting member, and the second regulating component is movably connected to both the second mounting member and the third mounting member, and is configured to adjust the second mounting member and the third mounting member to move relative to each other.

3. The regulating device according to claim 2, wherein the second mounting member comprises a first side and a second side that is adjacent to the first side; and
wherein the first mounting member is movably connected to the first side of the second mounting member, and the third mounting member is movably connected to the second side of the second mounting member.

4. The regulating device according to claim 1, wherein one of the first mounting member and the second mounting member comprises a first movable slot, and another of the first mounting member and the second mounting member comprises a first movable projection; and
wherein in response to adjustment of said first regulating component, the first movable projection is configured to move relative to the first movable slot.

5. The regulating device according to claim 1, wherein one end of the first mounting member adjacent to the second mounting member is provided with a first projection;
wherein the second mounting member comprises a rotating slot and an inner wall of the rotating slot is provided with a second projection; and
wherein the first projection and the second projections are rotatably connected, enabling the first projection to rotate relatively to the rotating slot.

6. The regulating device according to claim 5, wherein one end of the first mounting member adjacent to the second mounting member is provided with a limiting member and the limiting member is capable of abutting against the rotating slot to restrict the first projection to rotate.

7. The regulating device according to claim 2, wherein one of the second mounting member and the third mounting member comprises a second movable slot, while another comprises a second movable projection; and
wherein in response to adjustment of the second regulating component, the second movable projection moves relative to the second movable slot.

8. The regulating device according to claim 2, wherein the first mounting member comprises a first mounting hole, two ends of the second mounting member respectively comprise a second mounting hole and a third mounting hole, and the third mounting member comprises a fourth mounting hole;
wherein the first regulating component passes through and the first regulating component is threaded with both the second mounting hole and the first mounting hole; and
wherein the second regulating component passes through and the second regulating component is threaded with both the fourth mounting hole and the third mounting hole.

9. The regulating device according to claim 2, wherein the regulating device further comprises a mounting base connected to the third mounting member.

10. The regulating device according to claim 9, wherein the mounting base comprises a first base body and a second base body;
wherein a first end of the first base body is movably connected to the second base body, while a second end is provided with a back-up block; and
wherein one end of the second base body opposite to the first base body is provided with a hook.

11. An audio stand, comprising a stand pole, a support rod, and the regulating device according to claim 1;
wherein the stand pole is configured for mounting a microphone, with a first end of the support rod movably connected to the stand pole and a second end connected to the regulating device.
